(19) United States
(12) Patent Application Publication
(10) Pub. No.: US 2006/0000554 A1
(43) Pub. Date: Jan. 5, 2006

(54) Cover plate for tire building drum

(76) Inventors: Steven Leonard Kitz, Tallmadge, OH (US); Steven Joseph Lake, North Canton, OH (US); Steven John Phippen, Napanee (CA)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/881,117

(22) Filed: Jun. 30, 2004

(51) Int. Cl. B29D 30/24

(52) U.S. Cl. 156/417; 156/414

(57) ABSTRACT

The invention provides in a first aspect a tire building drum comprising a plurality of segments in a cylindrical array, a cover plate mounted over the segments, wherein the cover plate has one or more ribs aligned with the longitudinal axis of the cover plate. The invention provides in another aspect a cover plate for use with a tire building drum, the cover plate comprising an upper surface and one or more longitudinal ribs connected to the upper surface.

### FIELD OF THE INVENTION

The present invention relates in general to tire building drums, and more specifically to tire building drums having cover plates.

### BACKGROUND OF THE INVENTION

All terrain vehicle tires, aircraft tires and other tires have relatively longer sidewalls as compared to passenger tires. The longer sidewalls result in a longer chord length (i.e., the bead to bead distance) as compared to passenger tires. A longer chord length results in longer cover plates, which are mounted on the outer surface of a first stage tire building drum. Because the cover plates are longer, flexing or bending about their longitudinal axis may occur during the stitching operation. The stitching operation presses a gear-like device to the tire component layers successively mounted on the tire building drum. The function of the stitching operation is to eliminate trapped air from between the tire component layers of the green tire, and to promote adhesion of the layers. If excessive flexing of the cover plates occur, the stitching operation may not be effective in removing the trapped air between the layers. This may ultimately result in a defective tire.

Thus an improved cover plate and tire building drum which eliminates the problem of trapped air is desired.

### SUMMARY OF THE INVENTION

The invention provides in a first aspect a tire building drum comprising a plurality of segments in a cylindrical array, a cover plate mounted over said segments, wherein said cover plate has one or more ribs aligned with the longitudinal axis of the cover plate.

The invention provides in another aspect a cover plate for use with a tire building drum, the cover plate comprising an upper surface and one or more longitudinal ribs connected to said upper surface.

### BRIEF DESCRIPTION OF THE DRAWINGS

The invention will be described by way of example and with reference to the accompanying drawings in which:

FIG. 1 is a perspective view of a first stage tire building drum;

FIG. 2 is a cutaway view in the direction 2-2 of FIG. 1;

FIG. 2a is a cutaway view in the direction 2-2 of FIG. 1, shown in the radially expanded condition;

FIG. 3 is a perspective view of a coverplate of the present invention;

FIG. 4 is a top view of the coverplate of the present invention shown in FIG. 3;

FIG. 5 is a side view of the coverplate of the present invention shown in FIG. 3;

FIG. 6 is an end view of the coverplate shown in FIG. 3;

FIG. 7 is a perspective view of a second embodiment of a coverplate of the present invention;

FIG. 8 is an exploded, perspective view of the cover plate of FIG. 7 and respective mounting plate;

FIG. 9 is a top view of the coverplate of FIG. 8;

FIG. 10 is a cutaway view in the direction 10-10 of FIG. 9;

FIG. 11 is a cutaway view in the direction 11-11 of FIG. 10.

### DETAILED DESCRIPTION OF THE INVENTION

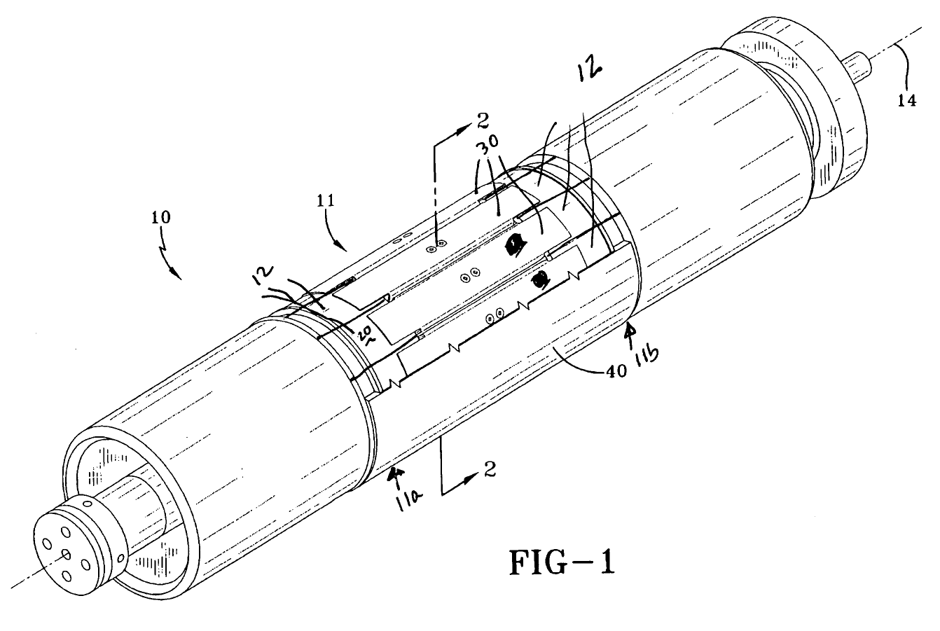

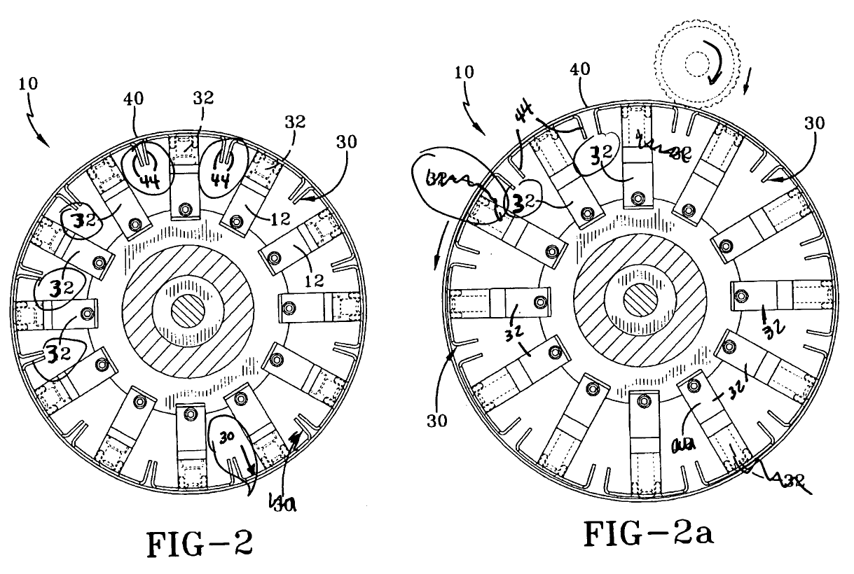

Turning to the drawings and in particular FIGS. 1-2, there is illustrated a first stage tire building drum 10 embodying improvements especially suited for building tires having a long chord length. The tire building drum 10 comprises a generally cylindrical shape and is rotatable about a longitudinal axis 14. The tire drum 10 has a center portion 11 for receiving successive layers of tire building components such as an inner liner, side walls, chafers, breakers, ply, and beads. The center portion 11 is also adapted to expand radially outward, in order to tighten up the tire building components over the wire beads and to turn up the ends over the beads. The center portion comprises a plurality of segments or fingers 12, which are radially actuatable. The segments 12 are arranged in a first and second cylindrical array about a drum axis 14 on each end 1 la,b of the drum. A plurality of coverplates 30 are positioned over the segments 12.

Each segment 12 has an upper mounting surface 20 for receiving a cover plate 30. Each segment 12 is radially actuatable via an air actuated piston (not shown) for moving the cover plates 30 radially outward. Cover plates 30 are mounted upon an upper mounting surface of a guide piston 32. The guide piston 32 functions to secure the coverplates to the drum and to allow the cover plates to move radially outward with the segments 12. FIG. 2A illustrates a cross sectional view of the tire building drum 10 in the radially expanded position wherein all of the segments are in the expanded position. FIG. 2 illustrates the tire building drum in the normal or retracted position.

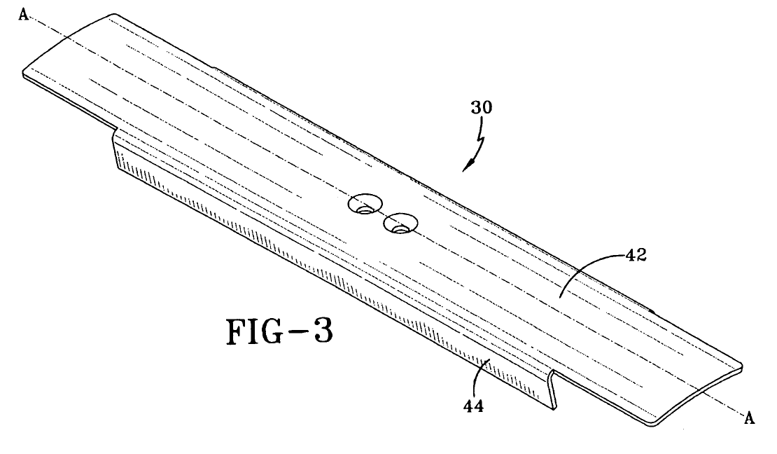

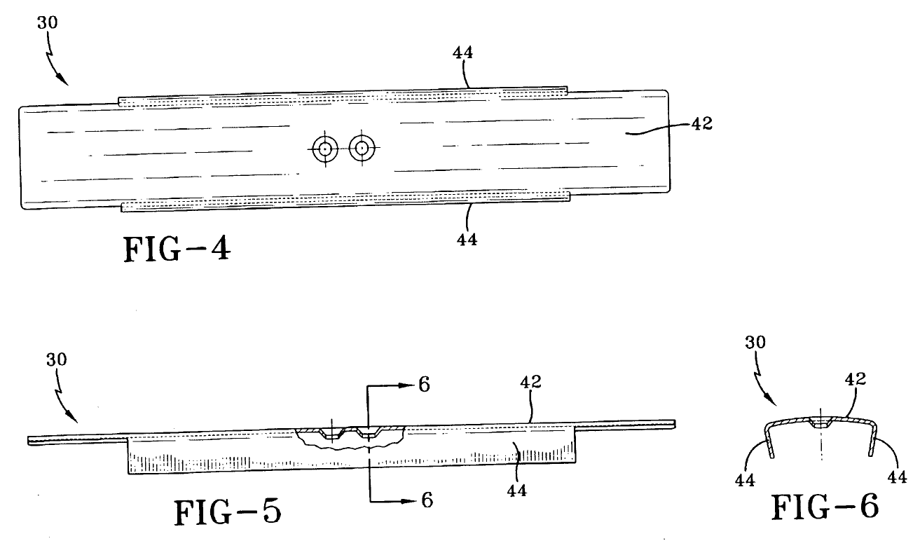

FIGS. 3-6 illustrate more details of the cover plate of a first embodiment of the present invention. The cover plate 30 is located below flexible center sleeve 40. The center sleeve 40 is typically comprised of an elastomer or rubber and functions to retract the segments, like a rubber band, to the collapsed position as shown in FIG. 2. The cover plate 30 as shown in FIG. 3 is generally rectangular in shape with its longitudinal axis A-A aligned with the longitudinal axis 14 of the tire building drum. The cover plate further includes a curved outer surface 42 and one or more ribs 44 that are preferably aligned with the longitudinal axis A-A of the cover plate. Preferably, there are two ribs 44 located on opposite ends of the cover plate as shown in the figures. In the preferred embodiment, the ribs 44 extend down as sidewalls from the cover plate, and are oriented at about a ninety degree angle with respect to the outer surface 42. It is desired that the ribs 44 do not extend along the entire length of the cover plate in order to avoid interference with the segments 12.

In a second embodiment of the cover plate (not shown), the cover plate comprises a single rib aligned or parallel with the longitudinal axis A-A of the cover plate. Preferably, the single rib is located on the longitudinal axis. However, the rib may also be located on one end of the cover plate.

Ribs 44 function to increase the structural rigidity of the cover plate in order to prevent flexing of the cover plates during the stitching operation. FIG. 2a illustrates a stitcher in contact with the cover plates 30 of the tire building drum.

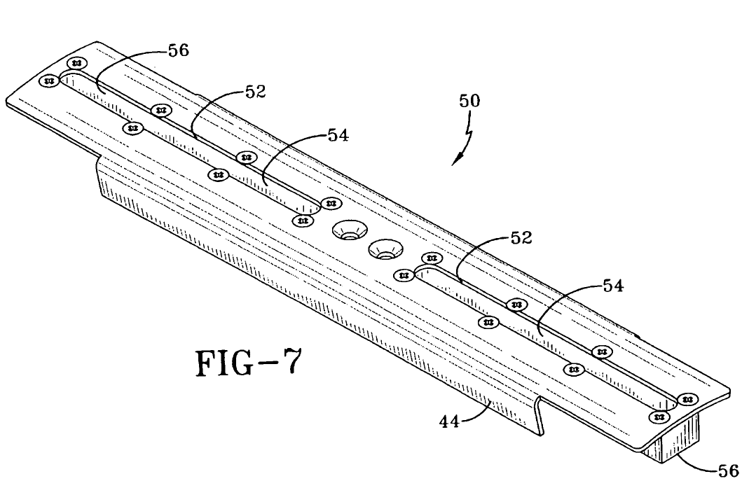

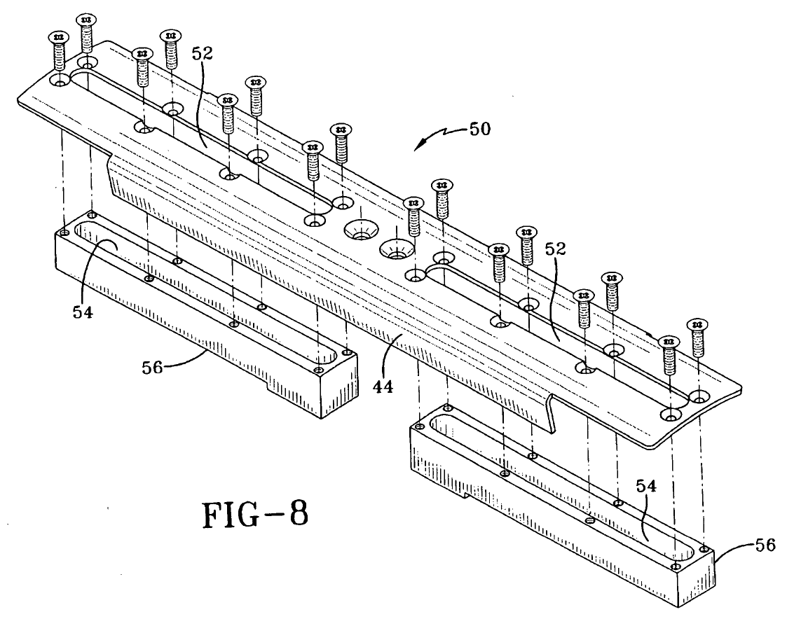

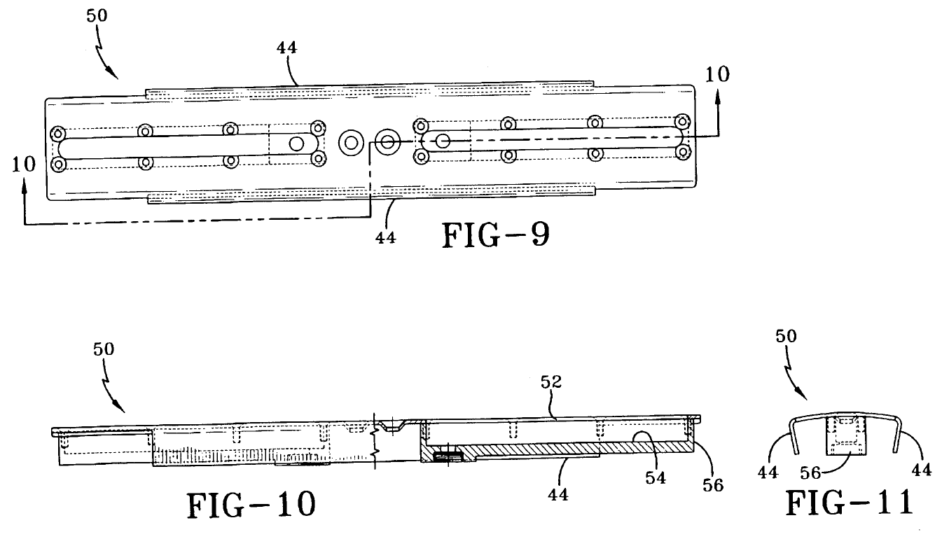

A third embodiment of the cover plate 50 is shown in FIGS. 7-11. The cover plate has one or more sidewalls extending down from the upper surface, wherein the sidewalls form longitudinal ribs 44. The cover plate 50 further comprises longitudinal slots 52 which together with the lots 54 of backing plate 56, form a manifold for vacuum. When the vacuum system (not shown) is turned on, the cover plates with slots hold the tire components onto the drum via suction.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire building drum comprising: a plurality of segments in a cylindrical array, a cover plate mounted over said segments, wherein said cover plate has one or more ribs aligned with the longitudinal axis of the cover plate.

2. The tire building drum of claim 1 wherein said cover plate has two or more ribs.

3. The tire building drum of claim 1 wherein said cover plate has an upper curved surface and sidewalls extending down from said upper surface.

4. The tire building drum of claim 3 wherein said sidewalls are oriented about 90 degrees with respect to the upper curved surface.

5. The tire building drum of claim 1 wherein said segments are actuatable in the radial direction.

6. A cover plate for use with a tire building drum, said cover plate comprising an upper surface and one or more longitudinal ribs connected to said upper surface.

7. The cover plate of claim 6 comprising two opposed ribs.

8. The cover plate of claim 6 comprising a single rib aligned with the longitudinal axis of said cover plate.

9. The cover plate of claim 6 wherein said one or more ribs are oriented about 90 degrees with respect to the upper surface.
